(19) United States
(12) Patent Application Publication
(10) Pub. No.: US 2004/0015918 A1
(43) Pub. Date: Jan. 22, 2004

(54) Program optimization method and compiler using the program optimization method

(76) Inventors: Motohiro Kawahito, Sagamihara-shi (JP); Hideaki Komatsu, Yokohama-shi (JP); John Craig Whaley, Mountain View, CA (US)

Correspondence Address: IBM CORPORATION, INTELLECTUAL PROPERTY LAW DEPT., P.O. BOX 218 - 39-254, YORKTOWN HEIGHTS, NY, 10598, US

(21) Appl. No.: 10/085,455

(22) Filed: Feb. 27, 2002

(30) Foreign Application Priority Data
Feb. 28, 2001 (JP) 2001-055996

(51) Int. Cl. G06F 9/45

(52) U.S. Cl. 717/151; 717/154; 717/158

(57) ABSTRACT

A compiler 10 comprises: an impact analysis unit 12 for performing an analysis to determine how much the execution speed of a program to be compiled can be increased by fixing, in a specific state, a parameter of a predetermined command in the program; a data specialization selector 13 for, when the program is executed, obtaining statistical data for the appearance frequency of each state, obtained by the impact analysis unit 12, and for determining the state where the parameter of the predetermined command is to be set; and a specialization and compiling unit 14 for, based on the results obtained by the impact analysis unit 12 and the data specialization selector 13, generating, in the program, a specialized path along which the parameter of the predetermined command is fixed in the specific state.

### TECHNICAL FIELD

The present invention relates to a method for optimizing a computer program, and in particular to an optimization method for the specialization of a program based on the property of data at the time of execution.

### BACKGROUND ART

In the process for compiling the source code of a program written in a programming language, generally the program is optimized in order to increase the execution speed of a computer.

There are various optimization methods, and for a program written in an object-oriented programming language, one optimization method provides for the specialization of a program based on the property of data when the program is executed.

Conventional program specialization methods are: 1. a specialization method performed only at the compile time using a static compiler, and 2. a specialization method performed at the bind time and at the time of execution using a static compiler.

An example first method is:

Flow-Sensitive Interprocedural Constant Propagation: PLDI (Programming Language Design and Implementation) '95, and An example second method is:

Efficient Incremental Run-Time Specialization for Free: PLDI '99.

According to the specialization method performed only at compile time using a static compiler, first, arguments for method calls in a program are analyzed to detect “an argument that it is determined always has the same constant value”, which is then used to perform the specialization.

According to the specialization method performed at the time of binding and at the time of execution using a static compiler, specialization in a program is especially performed for a nested loop. That is, specialization is performed for a variable that is unchanged in the body of each nested loop. While this method includes a feature whereby specialization of a program is performed for each nesting, basically, in addition to the specialization method performed at compile time, a specialization method is performed at the location whereat a method call should be issued.

However, according to the conventional optimization methods used for specialization in programs, specialization of call methods is effected at locations whereat method calls should be issued, so that many specialization methods are required to cope with an argument pattern, while execution codes corresponding to the specialized methods are generated. As a result, the compile time is extended and the size of the memory that is used is increased.

Further, from the viewpoint of an extension in compile time and an increase in the memory capacity required, it is difficult for a conventional optimization method for the specialization of a program to be applied for a dynamic compiler (a compiler run at program execution time), such as a JIT compiler (Just In Time compiler) used for Java.

Furthermore, for a program using a dynamic call function prepared in Java, a call method can not be specified at the location whereat a method call is issued. Therefore, it is not practical to specialize a conventional program for the specialization of a call method at a location whereat a method call is issued.

### SUMMARY OF THE INVENTION

It is, therefore, one object of the present invention to reduce, for a compiler that performs program optimization using specialization, the compile time and the amount of memory that is required.

It is another object of the present invention to enable specialization even when a call method can not be specified at a location whereat a method call is to be issued.

To achieve the above objects, according to the present invention, a program optimization method for translating, into machine code, the source code for a program written in a programming language, and for optimizing the program comprises the steps of: performing an analysis to determine whether the execution speed of a program to be optimized can be increased by fixing, in a specific state, a parameter for a predetermined command in the program; and employing the analysis results for the generation and specialization, in the program, of a path along which the parameter of the predetermined command is fixed in the specific state. According to the invention, the program is so optimized that on a path (a specialized path) along which the parameter of the predetermined command is fixed and on a path (an unspecialized path) along which this parameter is not fixed in the specific state is selectively executed during the branching process. Thus, when the specialized path is executed, the program execution speed can be increased, and when the ratio for executing the specialized path is large, the overall execution efficiency of the program can be improved.

The step of generating a path includes the steps of: executing the program and obtaining statistical data for the appearance frequency of each available state wherein, according to the analysis results, the parameter of the predetermined command may be set; and employing the obtained statistical data to generate a path along which the parameter of the predetermined command is fixed in the specific state.

Using the statistical process, the probability the specialized path will be executed can be accurately determined.

According to the present invention, a program optimization method comprises the steps of: executing a program to be optimized to obtain statistical data for the appearance frequency of each available state in which a parameter of a predetermined command in the program may be set; and employing the obtained statistical data to generate a machine language program that includes, as the compiling results, a path along which the parameter of the predetermined command is fixed in a specific state.

The program optimization method further comprises a step of: generating a machine language program that does not include, as a compiling result, a path along which the parameter of the predetermined command is fixed in a specific state.

According to the invention, a program optimization method for performing the above described specialization comprises the steps of: detecting one command, of the commands in a program to be optimized, for which a method call destination can be identified, and for which the processing speed can be increased by identifying the method call destination; and generating a path wherefor the method call destination for the detected command is limited in order to increase the processing speed of the command.

According to the invention, another program optimization method for performing the above described specialization comprises the steps of: detecting one command, of the commands in a program to be optimized, for which a variable can be limited to a predetermined constant value, and for which the processing speed can be increased by limiting the variable to the constant value; and generating a path along which the constant value of the variable of the detected command is fixed.

Further, according to the present invention, a compiler for translating into machine code the source code for a program written in a programming language, and for optimizing the resultant program comprises: an impact analysis unit for performing an analysis to determine how much the execution speed of a program to be compiled can be increased by fixing, in a specific state, a parameter of a predetermined command in the program; and a specialization unit for employing the analysis results obtained by the impact analysis unit to generate, in the program, a specialized path along which the parameter of the predetermined command is fixed in the specific state.

This compiler further comprises: a data specialization selector for, when the program is executed, obtaining statistical data for the appearance frequency of each state obtained by the impact analysis unit, and for determining the state in which the parameter of the predetermined command is to be set, wherein the specialization unit generates a specialized path along which the parameter of the predetermined command is fixed in a state determined by the data specialization selector.

In accordance with the state of the program at execution, the specialization unit generates, in the program, a branching process for selectively performing a specialized path and an unspecialized path, and while taking into account a delay due to the insertion of the branching process, the data specialization selector determines a state in which the parameter of the predetermined command is fixed.

Furthermore, according to the invention, a computer having the following configuration can be provided. The computer comprises: an input device for receiving source code for a program; a compiler for translating the source code to compile the program and for converting the compiled program into machine language code; and a processor for executing the machine language code, wherein the compiler includes means for performing an analysis to determine whether the execution speed of the program can be improved by fixing in a specific state a parameter of a predetermined command in the program, and means for generating in the program, based on the analysis results, a path along which the parameter of the predetermined command is fixed in the specific state and for compiling the program, and wherein the compiler outputs, as the compiled results, the machine language code that includes the path along which the state of the parameter is fixed.

In addition, according to the present invention, a computer having the following configuration can be provided. The computer comprises: an input device, for receiving source code for a program; a compiler, for translating the source code to compile the program and for converting the compiled program into machine language code; and a processor, for executing the machine language code, wherein the compiler includes means for obtaining statistical data for the appearance frequency of each available state wherein a parameter for a predetermined command in the program may be set when the program is executed, and for employing the statistical data to determine a state in which the parameter of the predetermined command is to be fixed, and means for generating a specialized path along which the parameter of the predetermined command is fixed in the determined state, and for compiling the program, and wherein the compiler outputs, as the compiled results, the program as the machine language code that includes the specialized path.

The compiler further comprises: means for compiling the program without generating a specialized path, wherein, when the state of the parameter to be fixed can not be determined, the means for determining the state of the parameter of the predetermined command outputs, as compiled results, the program in the machine language code, which is generated by the means for compiling the program without generating the specialized path, that does not include the specialized path.

Further, the present invention can be provided as a computer support program having the following configuration. The support program, for controlling a computer to support generation of a program, permits the computer to perform: a function for performing an analysis to determine whether the execution speed of the program can be increased by fixing a parameter of a predetermined command of the computer program in a specific state; and a function for generating in the program, based on the analysis results, a path along which the parameter of the predetermined command is fixed in the specific state.

Another support program, for controlling a computer to support generation of a program, permits the computer to perform: a function for executing the program and obtaining statistical data for the appearance frequency of each available state wherein the parameter of the predetermined command of the program may be set; and a function for generating in the program, based on the statistical data, a path along which the parameter of the predetermined command is fixed in the specific state.

Moreover, the present invention can be provided as a storage medium whereon the above described computer-readable program is stored by computer input means, or as a program transmission apparatus for transmitting the computer-readable program via a network.

As is described below, according to the invention, since the impact analysis process and the statistical process are performed, both the compiling time and amount of memory used for compiling can be reduced.

Furthermore, according to the invention, specialization can be performed even when a call method can not be specified at the location whereat a method call is to be issued.

### BRIEF DESCRIPTION OF THE DRAWINGS

FIG. 1 is a diagram for explaining the general configuration of a compiler according to one embodiment of the present invention.

FIG. 2 is a flowchart for explaining the general processing performed by the compiler according to the embodiment.

FIG. 3 is a table showing the correlation between specialization types and specialization commands.

FIG. 4 is a diagram for explaining the algorithm according to the embodiment for the impact analysis process for the specialization of a parameter.

FIG. 5 is a diagram showing the algorithm according to the embodiment for the process for estimating the effects of parameter specialization.

FIG. 6 is a diagram for explaining the algorithm according to the embodiment for the statistical process performed by the data specialization selector for parameter specialization.

FIG. 7 is a diagram for explaining the algorithm according to the embodiment for the process for selecting specialization target data for parameter specialization.

FIG. 8 is a diagram showing a sample program according to the embodiment that is used as an example for parameter specialization.

FIGS. 9A and 9B are diagrams showing the impact analysis results for the sample program in FIG. 8.

FIG. 10 is a diagram showing example statistical data for the sample program in FIG. 8.

FIG. 11 is a diagram showing a source program when specialization is performed for the sample program in FIG. 8.

FIG. 12 is a diagram showing a sample program used as another example for the parameter specialization performed according to the embodiment.

FIG. 13 is a diagram showing the state wherein optimization is performed for the sample program in FIG. 12 during the normal compiling process.

FIG. 14 is a diagram showing the impact analysis results obtained for the sample program in FIG. 12.

FIG. 15 is a diagram showing a source program when specialization is performed for the sample program in FIG. 12.

FIG. 16 is a diagram showing a source program when specialization for the sample program in FIG. 12 is performed under another condition.

FIG. 17 is a diagram for explaining the algorithm according to the embodiment for the impact analysis process performed for the specialization of global data.

FIG. 18 is a diagram showing a sample program used as an example for the specialization of global data according to the embodiment.

FIG. 19 is a diagram showing the state wherein the normal compiling optimization process is performed for the sample program in FIG. 18.

FIG. 20 is a diagram showing the results obtained by the performance of the impact analysis for the compiled results for the sample program 3 in FIG. 19.

FIG. 21 is a diagram showing a source program when specialization is performed for the program in FIG. 19.

### DESCRIPTION OF THE PREFERRED EMBODIMENTS

The preferred embodiment of the present invention will now be described in detail while referring to the accompanying drawings.

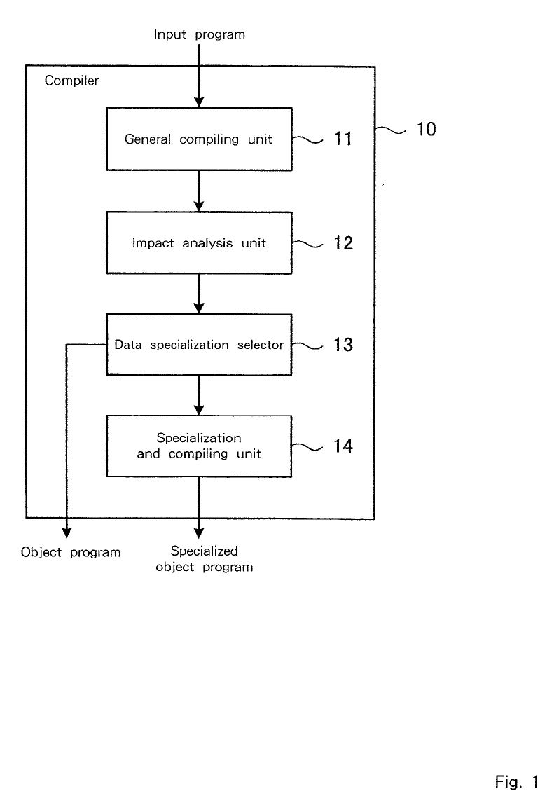

FIG. 1 is a diagram for explaining the general configuration of a compiler according to the embodiment of the present invention.

In FIG. 1, a compiler 10 according to the invention comprises: a general compiling unit 11, for performing the normal compiling process for an input program; an impact analysis unit 12, for performing an impact analysis for the compiling results obtained by the general compiling unit 11; a data specialization selector 13, for employing the analysis results obtained by the impact analysis unit 12 to select data for specialization; a specialization and compiling unit 14, for the specialization of the data selected by the data specialization selector 13 and the generation of an object program.

The components of the compiler 10 in FIG. 1 are virtual software blocks that are implemented by a computer program controlled CPU. The computer program for controlling the CPU can be distributed either on a storage medium, such as a CD-ROM or a floppy disk, or via a network.

In the above configuration, the general compiling unit 11 receives a source program as input, and uses a normal compiling process to generate an object program in a machine language code. When the compiler 10 is implemented as a JIT compiler in Java, the source program is converted to bytecode.

The impact analysis unit 12 performs an impact analysis for the object program that is produced by the general compiling unit 11, and prepares impact data for the data in the program. The impact analysis process is a process for examining “how the data in which program should be specialized to better perform optimization”. The analysis results are written as impact data. The impact analysis process will be specifically described later.

When, as a result of the impact analysis process performed by the impact analysis unit 12, it is determined there is data that will be affected by specialization, the data specialization selector 13 selects the data that is to be specialized. The object program generated by the general compiling unit 11 is performed multiple times, and statistical data for the appearance frequency of data are accumulated for the impact data prepared by the impact analysis unit 12. That is, a check is performed to determine the probability of a method being used to execute the data it is determined, as a result of the impact analysis, will be affected by specialization. Then, based on the obtained statistical data, data evaluation indicates will provide a predetermined number, or more, of effects when specialization is performed is determined to be specialized. The process for selecting data to be specialized will be specifically described later.

To obtain the statistics, a program should actually be executed. The system for executing a program initially executes an object program that has been normally compiled by the general compiling unit 11. After the statistical data has been obtained by repeating the object program a satisfactory number of times (an arbitrary number of repetitions can be performed to obtain the statistical data), and the data for which specialization is to be performed is selected.

It should be noted that this execution of an object program may merely be a trial used for obtaining statistical data. In this case, when the object program is to be used by an actual system, this program is compiled while it is appropriately specialized initially.

When it is found as a result of the impact analysis process that no data that will be affected by specialization is present, the data specialization selector 13 simply outputs an object program obtained by the general compiling unit 11, and the above statistical process is not performed.

Further, as the statistical results obtained by the data specialization selector 13, when data to be specialized is not present, or when the number of executions of the program does not reach the count that is set for the statistical process, the object program generated by the general compiling unit 11 is output without the specialization and compiling unit 14 performing specialization.

The specialization and compiling unit 14 performs a specialization process for target data that are selected by the data specialization selector 13, and generates and outputs a specialized object program. During the specialization process performed for a program, a parameter of a predetermined command is fixed in a specific state (the parameter is changed to a constant value, or a call destination is designated) so as to eliminate a process, such as one performed for determining the state of a parameter, that is accompanied by the setting of the parameter to multiple states. The specialization process is performed for each type and property of target data. For example, a constant in the command is fixed to a value that most frequently appears, or a method call destination is designated as the destination most frequently called.

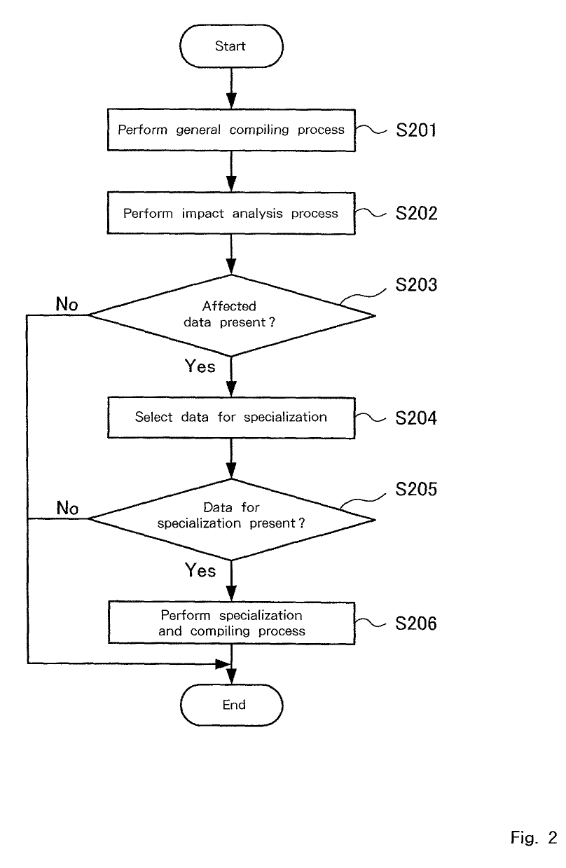

FIG. 2 is a flowchart for explaining the general processing performed by the compiler 10 in this embodiment.

In FIG. 2, first, a source program is input to the general compiling unit 11, and a normal compiling process is performed for the source program (step 201).

Then, the impact analysis unit 12 performs an impact analysis for the object program that is the compiling result obtained by the general compiling unit 11 (step 202). When no data that is affected by specialization is present, the object program obtained by the general compiling unit 11 is output and the processing is thereafter terminated (step 203). In this case, the program execution system executes an object program that is compiled only by the general compiling unit 11.

When it is ascertained as a result of the impact analysis that data that is affected by specialization is present, the data specialization selector 13 performs the statistical process for that data and selects data for the specialization process (steps 203 and 204). When no data for the specialization process are present, the object program generated by the general compiling unit 11 is output and the processing is terminated (step 205).

When, as a result of the performance of the statistical process, it is found that no data for which the specialization process is to be performed are present, the program execution system executes an object program that is merely compiled by the general compiling unit 11.

When all data for which the specialization process is to be performed have not been processed because the number of times the process has been performed does not correspond to the number of repetitions set by the statistical process, the performance of the process is repeated until the number of repetitions equals the count set by the statistical process.

When the number of times the process is performed equals the count set by the statistical process, and when, as a result of the statistical process, it is determined that data for which the specialization process is to be performed are present, the specialization and compiling unit 14 performs the specialization process for the data (steps 205 and 206). As a result, the program execution system executes an object program for which specialization has been performed by the specialization and compiling unit 14.

An explanation will now be given for the impact analysis process performed by the impact analysis unit 12 and the process performed by the data specialization selector 13 for selecting data for specialization.

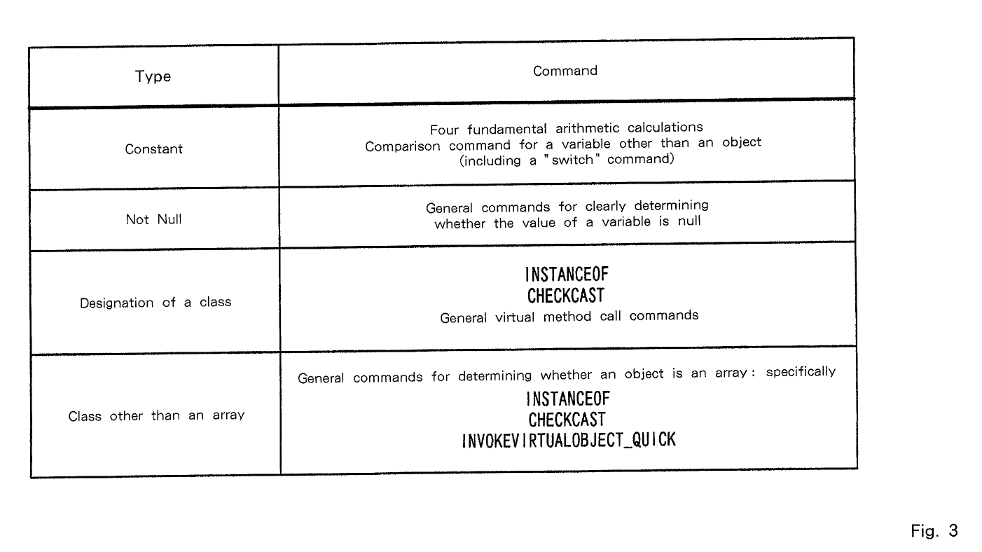

Examples for the specialization of a parameter and for the specialization of a parameter and global data are employed for a case wherein the embodiment is applied for the Java language. In the following explanation, ALLTYPE to designate all the specialization types that are mounted. FIG. 3 is a diagram showing example specialization types.

In the example in FIG. 3, “Constant”, “Not Null”, “Designation of a class” and “Class other than an array” are shown as specialization types. For type “Constant”, a specialization process is performed in which a constant in a predetermined program command is fixed at a specific value. For type “Not Null”, when a variable may be Null and when the processing speed can be increased if the variable is Null, the specialization process is performed in which a variable is fixed at Null. For type “Designation of a class”, when the method call destination can be limited and when the processing speed can be increased by limiting the method call destination, a specialization process is performed by which the method call destination is designated. For type “Class other than an array”, when a program is written in a programming language, such as Java, for which an array class can be obtained as the method call destination, the specialization process is performed for designating the method call destination as an array class. It should be noted that various specialization types can be set in accordance with the program type, the system in which the program is mounted and the operating environment.

Further, command types that may perform the above described specialization process are written in the command column in FIG. 3. When, for example, comparison commands relative to the four fundamental arithmetic calculations or variables other than an object are included in the program, the processing efficiency may be improved by performing the specialization of a “Constant” type for these commands. Similarly, when INSTANCEOF, CHECKCAST and virtual method call commands are included in the program, processing efficiency may be improved by performing the specialization of a “Designation of a class” type for these commands. Therefore, these commands are targets for the impact analysis process performed by the impact analysis unit 12.

(1) Specialization of a Parameter

An explanation will now be given for the operating algorithm for the embodiment used for the specialization of a parameter.

First, the general compiling unit 11 performs a normal compiling process (no specialization) for an input source program (see step 201 in FIG. 2). At this time, the UD-chain (use-definition chain) and DU-chain (definition-use chain) are also prepared.

Then, the impact analysis unit 12 performs the impact analysis process for the compiling results (an unspecialized object program) obtained by the general compiling unit 11 (see step 202 in FIG. 2).

During the impact analysis process, first, for a program parameter (variable), an estimate is made of the effects that will be obtained when specialization is performed for the individual types (see FIG. 3) that are designated, in advance, as targets for the impact analysis.

The effects obtained by specialization will now be described.

Specialization means that, for a command that includes a parameter for which multiple values can be set, a program is rewritten while assuming that a specific value has been set for the parameter. Accordingly, a process for inserting a guard code in front of the command and for branching to an unspecialized path must be performed in order to cope with a case wherein the parameter may have a value other than the specific value. Therefore, when the execution speed is unchanged even though the path has been specialized, the speed of execution of the entire program is reduced by a value equivalent to the time required to insert the guard code.

Whereas, if the execution speed is increased when specialization of the path has been performed, the speed of execution of the entire program may be increased even when there is a delay occasioned by the insertion of guard code.

Therefore, an estimate is made of the effect that will be obtained by specialization, and the estimate is compared with a threshold value A that employs, as a reference, a delay occasioned by the insertion of guard code, so that an impact level relative to the overall execution speed of the program can be examined. This impact level can be represented by using, for example, a ratio of the specialization effects to the delay caused by the insertion of guard code (hereinafter this value is called an impact value). In this case, an impact value of 1 means that an increase in the execution speed for the specialized path exactly offsets the delay time occasioned by the insertion of guard code (i.e., the overall execution speed of the program is unchanged).

When an increase in the execution speed for the specialized path has a predetermined or greater effect on the overall program execution speed, the parameter and a specific value for the specialization are included in the impact data as data that are affected by the specialization (hereinafter referred to as specialization target data). Further, an impact value relative to the overall execution speed of the program during the specialization process is included in the impact data.

If an appropriate threshold value A is set, the impact value to be provided for the execution speed of the program can be adjusted in order to write the specialization target data in the impact data, and if a small threshold value A is set, specialization target data that increase the program execution speed even slightly are written in the impact data. But when a large threshold value A is set, the specialization target data is not written in the impact data unless there is a considerable increase in the execution speed of the program. In this case, however, since the number of specialization target data sets to be written in the impact data is reduced, the cost incurred by the performance of the statistical process performed by the data specialization selector 13 is reduced, as is the load imposed on the CPU that employs the data specialization selector 13.

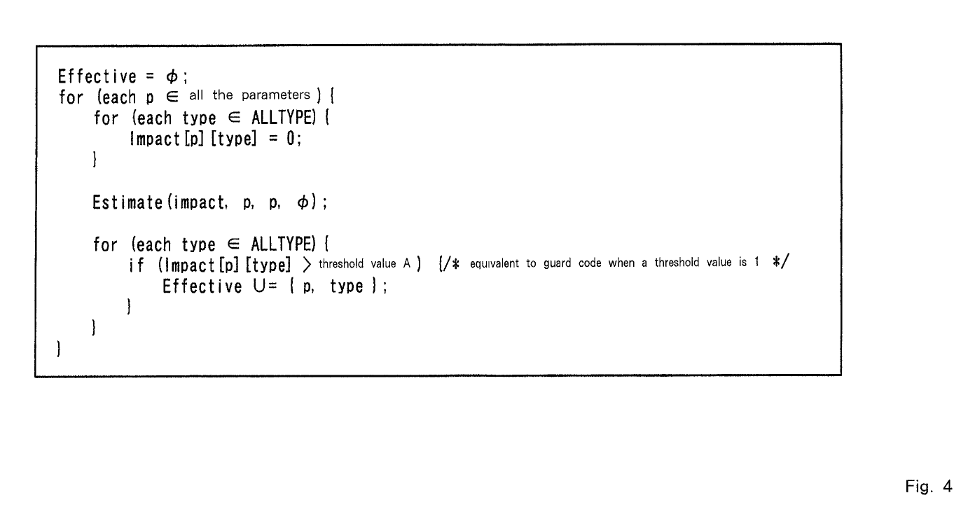

FIG. 4 is a diagram for explaining the algorithm of the impact analysis process for the specialization of the parameter.

The specialization effect estimate is on the sixth line of the algorithm in FIG. 4,

“Estimate(impact, p, p, φ);”

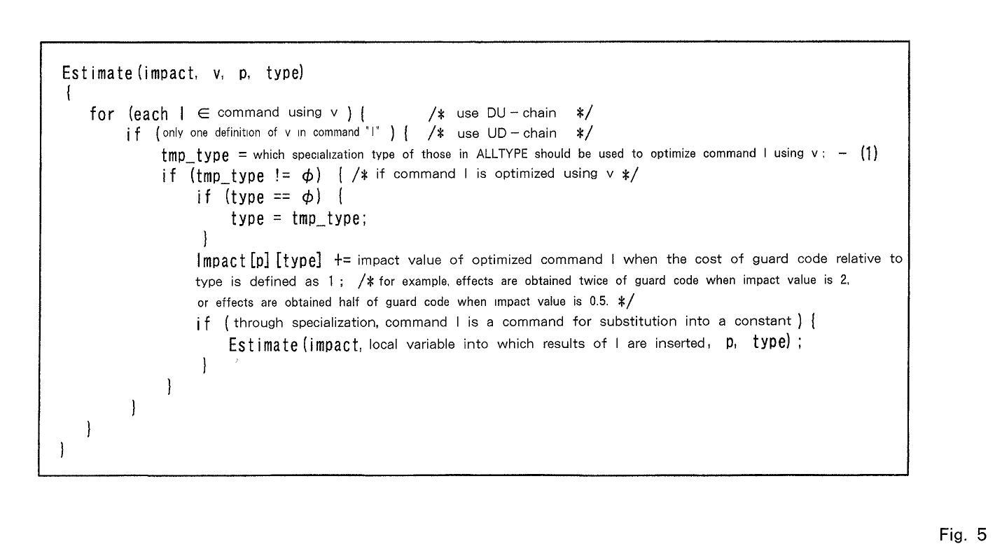

The specific contents (the algorithm) of this process are shown in FIG. 5.

On the eighth and ninth lines of the algorithm in FIG. 4

“if (Impact[p][type]>threshold value A)”

“Effective ∪={p, type};”

the specialization effects and the threshold value A are compared, and data to be written in the impact data are determined. As in the comment on the eighth line, when the threshold value A is 1, the execution speed for the specialized path is increased equivalent to the delay caused by the insertion of the guard code. Therefore, in order to increase the execution speed of the program, the setting for the threshold value A must be greater than 1.

Following this, the data specialization selector 13 selects data to be specialized, based on the impact analysis results obtained by the impact analysis unit 12 (see steps 203 and 204 in FIG. 2).

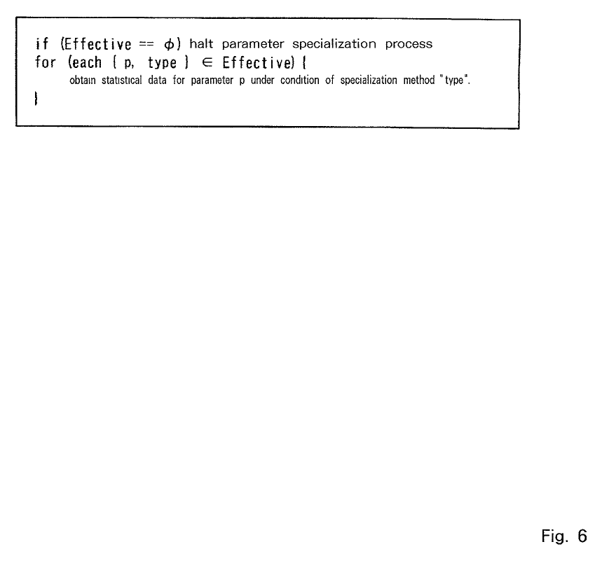

FIG. 6 is a diagram for explaining the algorithm for the statistical process performed by the data specialization selector 13.

In FIG. 6, as is shown on the third line, for the parameter (p) written in the impact data, the statistical process is performed under a condition inherent to a corresponding specialization method (type). Further, as is shown on the first line, the statistical process is not performed when data is not written in the impact data (Effective) (φempty set).

Then, the data specialization selector 13 selects data to be specialized (hereinafter referred to as specialization target data) based on the obtained statistical data.

As is described above, specialization means that, for a command including a parameter for which multiple values can be set, a program is rewritten while assuming that a specific value has been set for a parameter. Therefore, there are multiple values available for the parameter, and specialization variations equivalent in number to these values are present. Thus, an appearance frequency is statistically obtained for each of the specialization variations, and the value that is available for the parameter and that appears most frequently is selected and defined as the specialization target data.

However, if relative to the entire program the probability for the thus selected value is not sufficiently high, the overall processing efficiency of the program may not be improved. That is, multiple values may be set for the parameter, and when the probability of these values appearing is substantially the same, the appearance probability for the value that appears most frequently may not be sufficiently high. In this case, since it is highly probable that execution will take place along an unspecialized path even though specialization has been performed, the delay caused by the insertion of the guard code greatly affects the overall execution speed of the program.

Therefore, in this embodiment, for a value that can be set for a parameter and that appears most frequently, the probability that this value will be set for the parameter is obtained from the statistical data. Thereafter, the probability whereat the most frequently appearing value will appear is multiplied by the impact value if specialization has been performed for this value. Then, the obtained product value is compared with a threshold value B, which employs as a reference the delay caused by the insertion of the guard code, and a check is performed to determine whether the overall processing efficiency of the program can be improved. When specific effects or better are obtained, the value that appears most frequently is finally selected as the specialization target data.

If an appropriate threshold value B has been set, the effect that optimization of the program through specialization provides for the overall efficiency of the program execution can be controlled. When a small threshold value B has been set, based on the above described concept, specialization is performed when it is assumed that the execution efficiency will be increased even slightly compared with when specialization has not been performed. When a large threshold value B is set, specialization will not be performed unless a considerable improvement in the efficiency of the program execution can be realized. However, in this case, since the portion to be specialized is limited to the portion for which specialization is effective, the load imposed on the CPU in the compiling process can be reduced and effective optimization can be carried out. Thus, so long as an appropriate threshold value B has been set, the specialization process can be performed without extending the compiling time too much, and the method of this embodiment can be applied for a dynamic compiler, such as a JIT compiler for Java, which compiles a program at the time of execution.

When the specialization target data, which is thus determined by the data specialization selector 13, is compared with the specialization target data, which is determined by the impact analysis unit 12, the specialization target data determined by the impact analysis unit 12 are those that are related to all the parameters in such a way that, when specialization of the parameters is performed, an increase in the overall speed at which the program is executed can be expected, while the specialization target data determined by the data specialization selector 13 are those that are related to the parameter in such a way that the overall efficiency of the program execution can be increased the most.

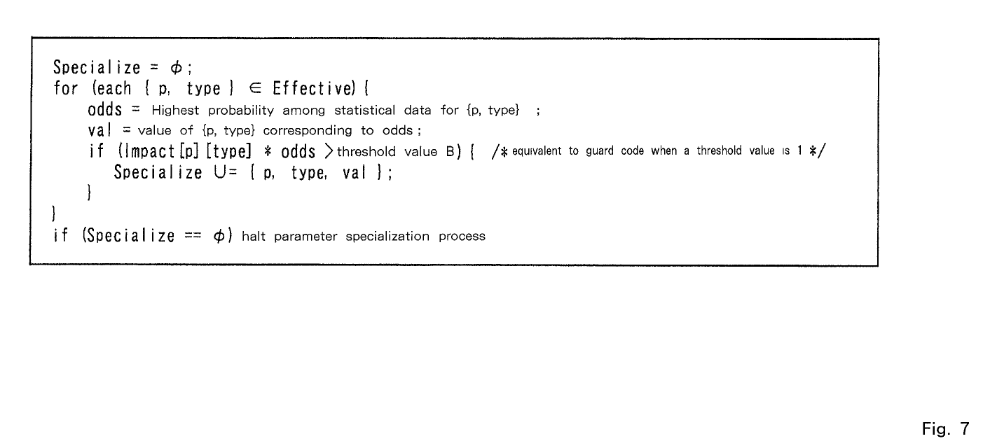

FIG. 7 is a diagram for explaining the algorithm of the process for selecting specialization target data for specializing a parameter.

On the third line of the algorithm in FIG. 7,

“the highest probability among the statistics concerning odds={p, type};”

the probability at which a value that can be set for the parameter appears most frequently is calculated. Further, on the fourth line,

“val=value {p, type} corresponding to odds;”

the value that appears most frequently is obtained. Then, on the fifth and sixth lines

“if (Impact[p][type]*odds>threshold value B)”

“Specialize ∪={p, type, val};”

the probability for the value that appears most frequently is multiplied by a corresponding impact value, the product value is compared with the threshold value B, and specialization target data is determined.

When, as is shown on the ninth line, the specialization target data (Specialize) is not determined for a predetermined parameter (φempty set), the specialization and compiling unit 14 does not specialize the parameter (see step 205 in FIG. 2).

Finally, the specialization and compiling unit 14 actually specializes the target data selected by the data specialization selector 13. The specialization process is performed in accordance with each parameter type and each specialization target data value.

As is described above, according to the embodiment, the efficiency of the program execution is examined based on the degree of the increase in the overall program execution speed provided by specialization, and the frequency whereat the specialized program is executed. Thus, while conventionally the specialization process is performed only for in extremely limited cases, e.g., a case wherein a constant value is always provided for a predetermined parameter, in the embodiment, the specialization process can be performed when specialization will increase the overall program execution efficiency.

Further, conventionally, before specialization, a check is performed to determine whether specialization can be performed for all the parameters in a program for which specialization is possible. However, in this embodiment, before specialization is performed by the specialization and compiling unit 14, dual processes are performed, i.e., the impact analysis unit 12 performs the impact analysis process and the data specialization selector 13 statistically obtains the actual appearance frequency of a specialization target value, so that the parameters that can be targeted for specialization can be narrowed down. Thus, an increase in the compiling time and in the memory that is used can be suppressed.

In addition, in this embodiment, instead of specializing the method used for a call at the location whereat a method call is issued, a method that actually has been called is analyzed and the specialization process is performed. Thus, the specialization process can be performed even when the method used for a call can not be identified at the location whereat a method call is issued.

An example wherein the specialization of the parameter is employed will now be explained.

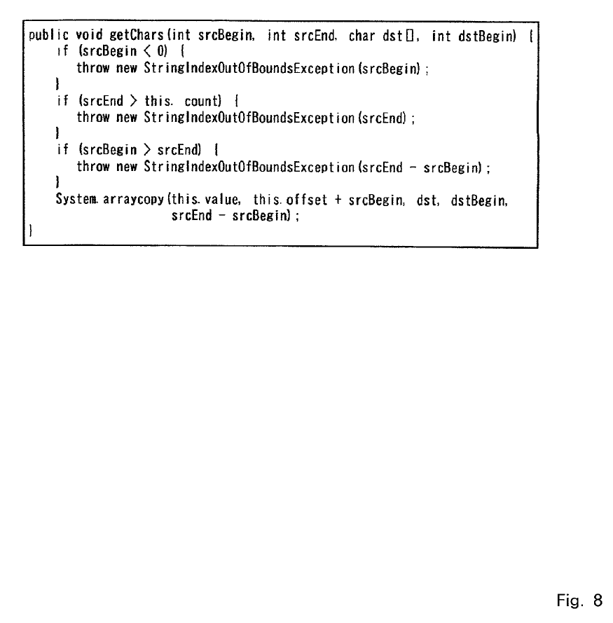

FIG. 8 is a diagram showing a sample program (hereinafter referred to as a first sample program) used for this example.

When the first sample program in FIG. 8 is input to the compiler 10, first, a normal compilation process is performed for the first sample program by the general compiling unit 11. It should be noted that there is no particular change in the first sample program during the normal compilation optimization processing. Further, since the first sample program is thereafter optimized during the compiling process, the result obtained is an object program written in a machine language. However, to simplify the explanation, the program is written as though it continued to be maintained as the source program. This is the same procedure that is employed for the following application examples.

Following this, the impact analysis unit 12 performs an impact analysis process for the compiling results obtained by the general compiling unit 11, and specialization target data is extracted from which effects would be obtained by specialization.

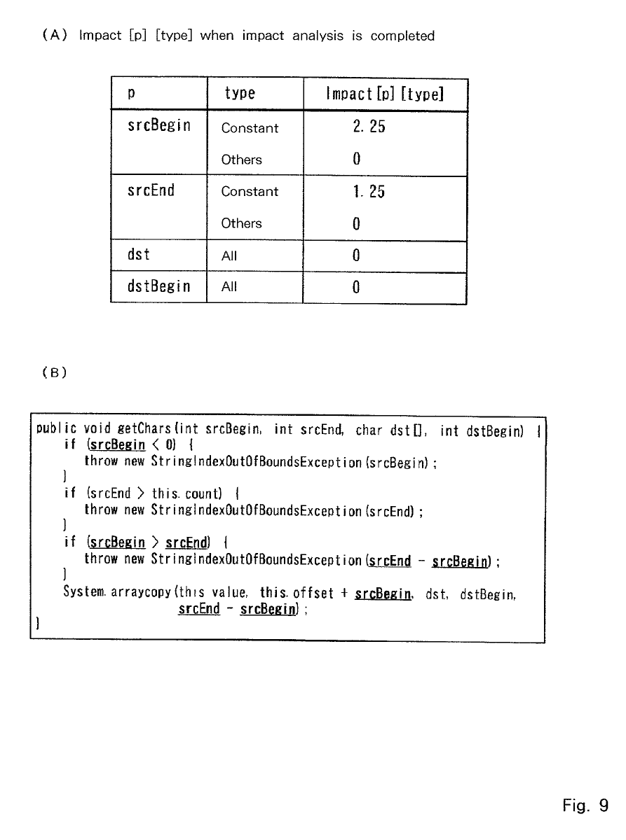

FIGS. 9A and 9B are diagrams showing the results provided by the impact analysis performed for the fist sample program in FIG. 8.

In FIG. 9A, when a specific constant value is designated as parameter (column p) srcBegin (when the “Constant” type specialization is performed), an impact value of 2.25 is obtained. And when a specific constant value is set for parameter srcEnd, an impact value of 1.25 is obtained. Therefore, it is apparent that, of the four parameters in the first program shown in FIG. 9A, the appearance frequency for a constant value need only be statistically obtained for two parameters, srcBegin and srcEnd. Information concerning these two parameters is written as specialization target data in the impact data.

In FIG. 9B, the positions in the source program of the first sample program of parameters srcBegin and srcEnd are indicated by using bold, underlined characters.

Following this, the data specialization selector 13 obtains the appearance frequency statistics for each of the values that are available for the parameters srcBegin and srcEnd.

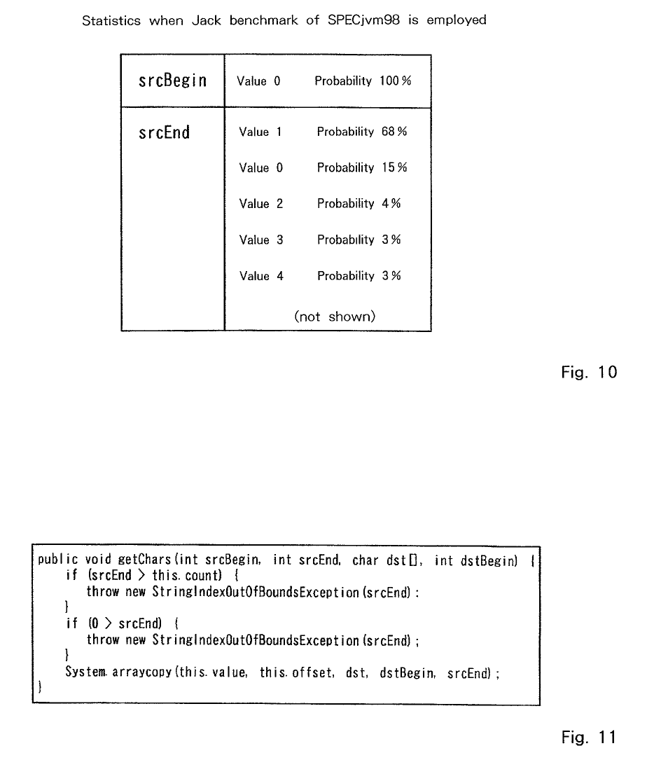

FIG. 10 is a diagram showing the example statistical data that is obtained. It should be noted that the statistical results in FIG. 10 are obtained when the Jack benchmark in SPECjvm98 is employed for the first sample program.

The data specialization selector 13 then determines the specialization target data based on the statistical data. While referring to the statistical results in FIG. 10, the probability whereat a value of 0 will be set as a constant value for srcBegin is 100%. For srcEnd, the probability whereat a value of 1 will be set as a constant value is 68%, the probability whereat a value of 0 will be set as a constant value is 15%, the probability whereat a value of 2 will be set as a constant value is 4%, the probability whereat a value of 3 will be set as a constant value is 3%, and the probability whereat a value of 4 will be set as a constant value is 3%. Since the probabilities of other values are small, they are not shown in FIG. 10.

According to the statistical data, since for srcBegin the probability whereat a specific value will appear is 100%, and the impact value is 2.25, the product of these two is 2.25. This value is greater than the value of the quotient obtained by dividing 1 by the value of the delay caused by the insertion of the guard code. Therefore, srcBegin is defined as specialization target data.

For srcEnd, since the probability whereat a value of 1 will appear most frequently is 68%, and the impact value is 1.25, the product value of the two is 0.85. This value is smaller than the quotient obtained by dividing a value of 1 by the value of the delay caused by the insertion of the guard code. Therefore, as the affect relative to the program execution efficiency, the delay caused by the insertion of the guard code is greater than the improvement in the execution speed due to the specialization of srcBegin. Further, since the probability whereat values other than 1 will appear is lower, it is apparent that relative to program execution efficiency the effect is further reduced. Therefore, in this example application, only srcBegin is used as the specialization target data.

Following the processing, the specialization and compiling unit 14 specializes, using a value of 0, srcBegin in the first sample program in FIG. 8, and compiles the program. FIG. 11 is a diagram showing a source program obtained when the specialization for the first sample program in FIG. 8 is performed in the above described manner.

Another parameter specialization example will now be described.

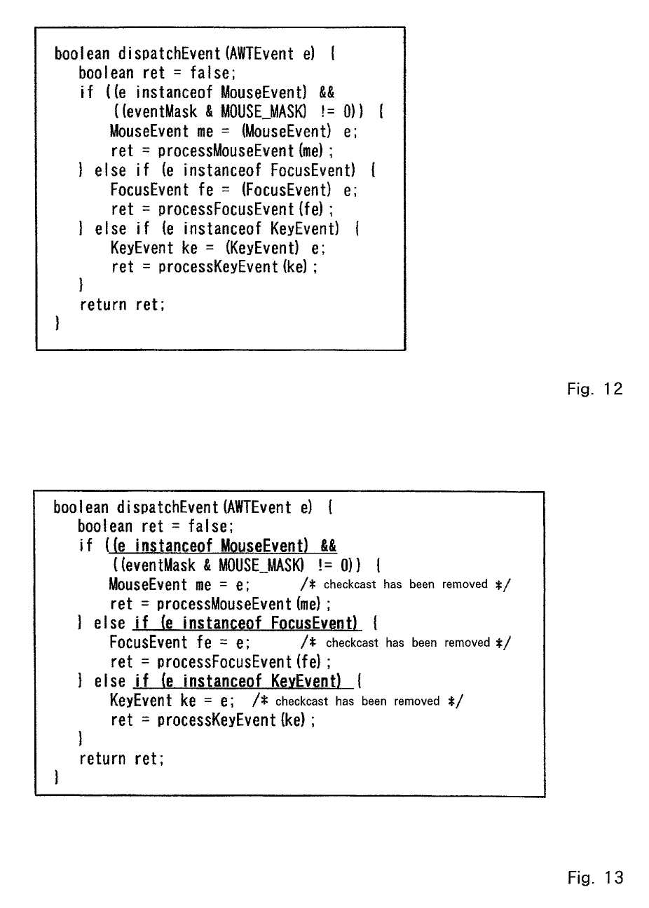

FIG. 12 is a diagram showing a sample program (hereinafter referred to as a second sample program) used for this example.

When the second sample program in FIG. 12 is input to the compiler 10, first, the general compiling unit 11 performs normal compiling for the second sample program.

FIG. 13 is a diagram showing the state wherein optimization is performed for the second sample program in FIG. 12 in the normal compiling process. In this case, a small amount of optimization, such as the removal of “checkcast”, is performed.

Then, the impact analysis unit 12 performs the impact analysis process for the compiled results obtained by the general compiling unit 11, and extracts specialization target data for which specialization effects can be estimated.

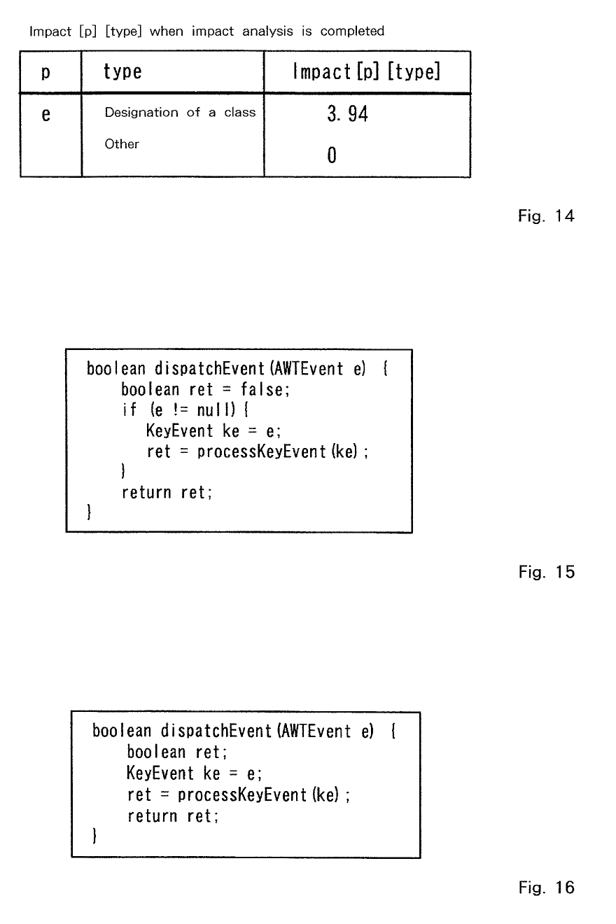

FIG. 14 is a diagram showing the impact analysis results obtained for the second sample program in FIG. 12.

While referring to FIG. 14, an impact value of 3.94 is obtained when the class of parameter e is designated. Therefore, it is understood that statistics for the class appearance frequency need only be obtained for the parameter e. Data concerning the parameter e is written as specialization target data in the impact data.

In the program in FIG. 13, portions indicated by bold, underlined are the portions that include the parameter e and for which the specialization effects can be estimated.

The data specialization selector 13 obtains the statistics for the appearance frequency for each available class for the parameter e, and determines specialization target data based on the obtained statistical data. Although specific statistical data is not shown, the appearance probability is highest when the parameter e belongs to the KeyEvent class. In this case, the product of the appearance probability and the impact value is defined as being greater than a value that is obtained by dividing 1 by the value of the delay caused by the insertion of the guard code. Therefore, the parameter e is determined to be the specialization target data.

Through the above processing, while compiling the second sample program, the specialization and compiling unit 14 specializes, into KeyEvent, the class of the parameter e in the second sample program in FIG. 12.

FIG. 15 is a diagram showing a source program when specialization of the second sample program in FIG. 12 is performed in the above described manner.

Assume that a combination of “Designation of a class” and “Not Null” is defined as a specialization type. In this case, through the above processing, the third line in FIG. 15, “If(e!=null)”, is specialized. FIG. 16 is a diagram showing a source program obtained using the above specialization.

(2) Specialization of Global Data

An explanation will now be given for an algorithm for the embodiment for the specialization of global data. The actual compiling process is performed without identifying specialization for global data with specialization for the above parameter. However, in this embodiment, for convenience sake, only specialization for global data will be explained, while in the example that will be described later, specialization of parameters and of global data are shown.

First, the general compiling unit 11 performs a normal (non-specialization) compiling process for a received source program (see step 201 in FIG. 2). At this time, Scalar replacement, in which global data is replaced by a local method variable, is optimized, and a UD-chain and a DU-chain are prepared.

As an algorithm for optimizing Scalar replacement, an algorithm is written in Lazy Code Motion: PLDI '92. This algorithm includes a portion for calculating set data called Down-Safety. Using this calculation, an area can be determined wherein, when the arithmetic expression of the method is operated in a direction opposite to that of an execution, the results provided by the expression are obtained as a set.

Therefore, when the Lazy Code Motion algorithm is employed for the optimization of a Scalar replacement, the Down-Safety data set is used, so that a set of accesses can be determined so that “accessing of global data can be moved to the head of the method” can be obtained. This obtained data is used for the specialization of the global data.

The impact analysis unit 12 performs the impact analysis process for the compiled results (an unspecialized object program) provided by the general compiling unit 11 (see step 202 in FIG. 2).

In the impact analysis process, first, assuming that “a set for which the access of global data can be moved to the head of the method” is included in “DownSafety [head of the method]”, a local variable is defined that includes the obtained results.

Thereafter, for the thus defined local variable, an estimate is made for the effects that are obtained when specialization is performed for each specialization type (see FIG. 3) set in advance as an impact analysis target. Then, the specialization target data is determined and impact data is generated. The contents of these operations are the same as those for the (1) specialization of a parameter.

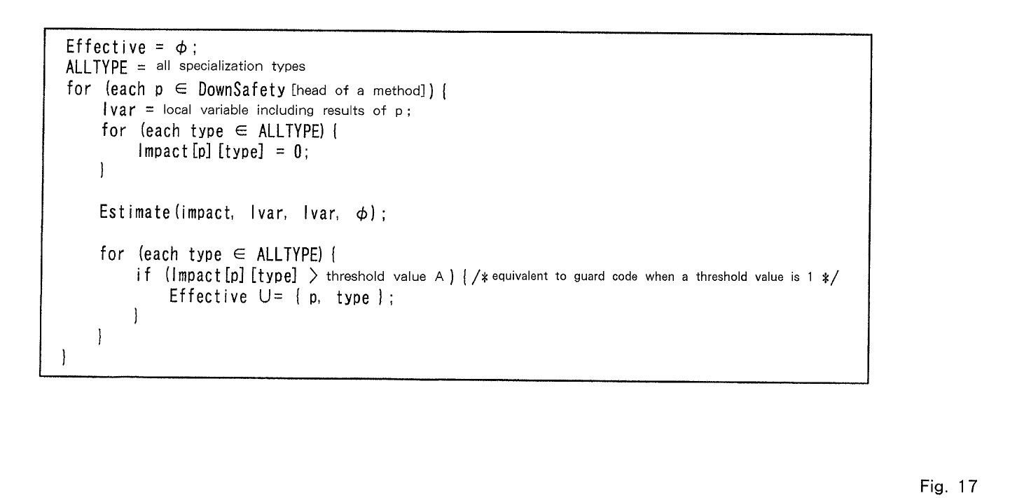

FIG. 17 is a diagram for explaining the algorithm for the impact analysis process for the specialization of global data.

A local variable for global data is obtained on the third and fourth lines of the algorithm in FIG. 17:

“for (each p ∈ DownSafety[head of the method])”

“lvar=local variable including the results of p;”.

Further, the contents of the process on the eighth line,

“Estimate(impact, lvar, lvar, φ);”

are the same as the process in FIG. 5 for estimating the effects of the specialization of a parameter.

Following this, the data specialization selector 13 performs a statistical process based on the impact analysis results obtained by the impact analysis unit 12, and determines the global data to be specialized and their values (target data) (see steps 203 and 204 in FIG. 2). These processes are the same as the above described parameter specialization process performed by the data specialization selector 13.

Finally, the specialization and compiling unit 14 actually performs the specialization of the target data selected by the data specialization selector 13. The specialization process is performed independently in accordance with each parameter type and each specialization target data value.

An example specialization of a parameter and global data will now be described.

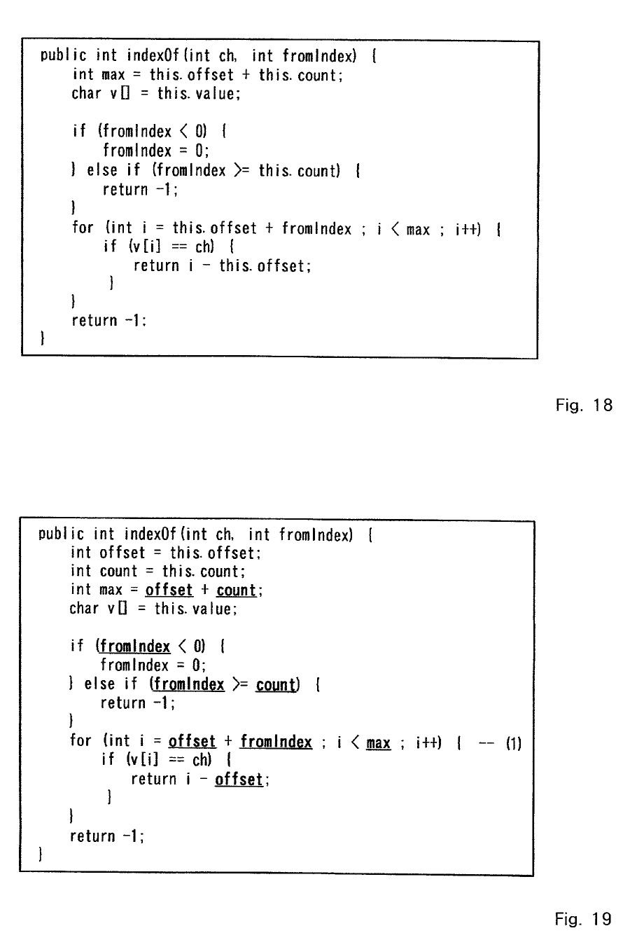

FIG. 18 is a diagram showing a sample program (hereinafter referred to as a third sample program) used for this example.

When the third sample program in FIG. 18 is input to the compiler 10, first, the general compiling unit 11 performs a normal compiling process for it.

FIG. 19 is a diagram showing the state wherein the normal optimization process is performed for the third sample program in FIG. 18.

Then, the impact analysis unit 12 performs the impact analysis process for the compiled results obtained by the general compiling unit 11, and extracts specialization target data for which the specialization effects can be estimated. In this case, the impact analysis process for the parameter and the impact analysis process for the global data are performed, without the two being separately identified.

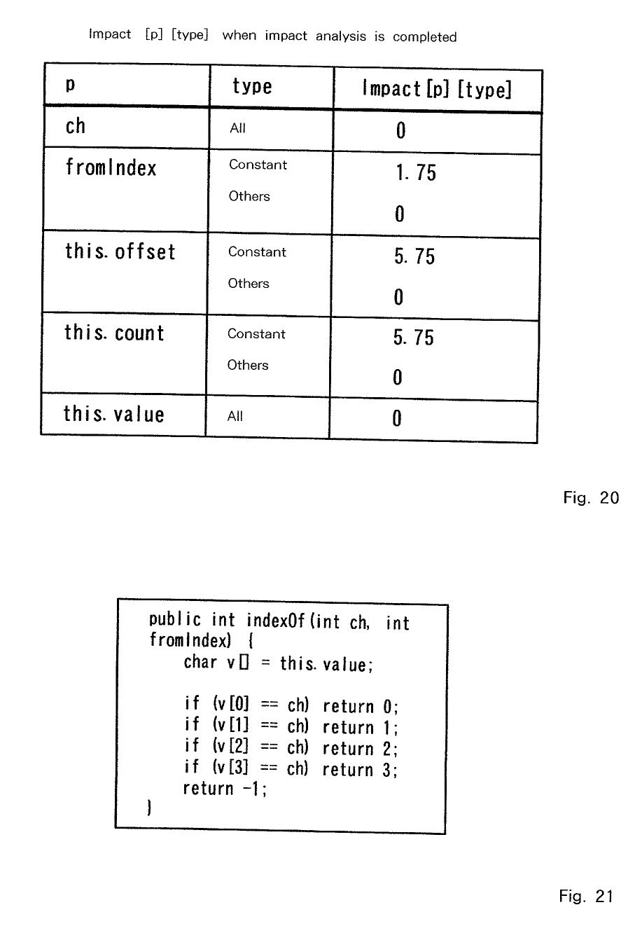

FIG. 20 is a diagram showing the results obtained by the performance of the impact analysis for the compiled results of the sample program 3 in FIG. 19.

While referring to FIG. 20, when a specific constant value is set for parameter fromIndex, an impact value of 1.75 is obtained. Further, when a specific constant value is set for parameter this.offset, an impact value of 5.75 is obtained, and when a specific constant value is set for parameter this.count, an impact value of 5.75 is obtained. Therefore, of the five parameters in FIG. 20, only the statistics for the appearance frequency of constant values for three parameters, fromIndex, this.offset and this.count, need be obtained. The data concerning these three parameters are written in the impact data as specialization target data.

Since, as is shown in FIG. 19, the global data, this.offset and this.count, in the sample program 3 are converted into local variables in the compiling process performed by the general compiling unit 11, it is found that in FIG. 20 these parameters are handled without being distinguished from other parameters, such as parameter ch.

The portions depicted using bold, underlined characters in the program in FIG. 19 are the positions of parameters fromindex, this.offset and this.count.

The data specialization selector 13 obtains statistical data for the appearance frequency for each available value for parameters fromindex, this.offset and this.count. Then, the specialization target data is determined based on the statistical data that has been obtained. While the statistical data is not specifically shown, the appearance frequency is highest when a constant value of 0 is set for fromIndex, when a constant value of 0 is set for this.offset, and when a constant value of 4 is set for this.count. The product of the appearance probability and the impact value in this case is greater than a value that is obtained by dividing 1 by the value of the delay caused by the insertion of the guard code. Therefore, parameters fromIndex, this.offset and this.count are determined to be specialization target data.

Thereafter, for the sample program 3 in FIG. 19 that has been normally compiled, the specialization and compiling unit 14 specializes parameters fromIndex, this.offset and this.count by respectively assigning them the values 0, 0 and 4, and compiles the resultant program.

FIG. 21 is a diagram showing the source program obtained through the above specialization process performed for the program in FIG. 19.

[Description of the Symbols]

10: Compiler

11: General compiling unit

12: Impact analysis unit

13: Data specialization selector

14: Specialization and compiling unit

Having thus described our invention, what we claim as new, and desire to secure by Letters Patent is:

1. A program optimization method for translating, into machine code, source code for a program written in a programming language, and for optimizing said program comprising the steps of:
performing an analysis to determine whether the execution speed of said program can be increased by fixing, in a specific state, a parameter for a predetermined command in said program; and
employing results of said analysis for the generation, in said program, of a path along which said parameter of said predetermined command is fixed in said specific state.

2. The program optimization method according to claim 2, wherein said step of generating a path includes the steps of:
executing said program and obtaining statistical data for the appearance frequency of each available state wherein, according to said results of said analysis, said parameter of said predetermined command may be set; and
employing said obtained statistical data to generate said path.

3. A program optimization method for translating, into machine code, the source code for a program written in a programming language, and for optimizing said program comprising the steps of:
executing a program to obtain statistical data for an appearance frequency of each available state in which a parameter of a predetermined command in said program may be set; and
employing said obtained statistical data to generate a machine language program that includes, as the compiling results, a path along which said parameter of said predetermined command is fixed in a specific state.

4. The program optimization method according to claim 3, further comprising a step of:
generating a machine language program that does not include, as a compiling result, a path along which said parameter of said predetermined command is fixed in a specific state.

5. A program optimization method for translating, into machine code, the source code for a program written in an object-oriented programming language, and for optimizing said program comprising the steps of:
detecting one command, of the commands in said program, for which a method call destination can be identified, and for which the processing speed can be increased by identifying said method call destination; and
generating a path wherefor said method call destination for said detected command is limited in order to increase the processing speed of said command.

6. A program optimization method for translating, into machine code, the source code for a program written in a programming language, and for optimizing said program comprising the steps of:
detecting one command, of the commands in said program, for which a variable can be limited to a predetermined constant value, and for which the processing speed can be increased by limiting said variable to said constant value; and
generating a path along which said constant value of said variable of said detected command is fixed.

7. A compiler for translating into machine code the source code for a program written in a programming language, and for optimizing the resultant program comprising:
an impact analysis unit for performing an analysis to determine how much the execution speed of said program can be increased by fixing, in a specific state, a parameter of a predetermined command in said program; and
a specialization unit for employing the analysis results obtained by said impact analysis unit to generate, in said program, a specialized path along which said parameter of said predetermined command is fixed in said specific state.

8. The compiler according to claim 7, further comprising:
a data specialization selector for, when said program is executed, obtaining statistical data for the appearance frequency of each state obtained by said impact analysis unit, and for determining the state in which said parameter of said predetermined command is to be set,
wherein said specialization unit generates a specialized path along which said parameter of said predetermined command is fixed in a state determined by said data specialization selector.

9. The compiler according to claim 8, wherein, in accordance with the state of said program at execution, said specialization unit generates, in said program, a branching process for selectively performing a specialized path and an unspecialized path; and wherein, while taking into account a delay due to the insertion of said branching process, said data specialization selector determines a state in which said parameter of said predetermined command is fixed.

10. A computer comprising:
an input device for receiving source code for a program;
a compiler for translating said source code to compile said program and for converting said compiled program into machine language code; and
a processor for executing said machine language code,
wherein said compiler includes
means for performing an analysis to determine whether the execution speed of said program can be improved by fixing in a specific state a parameter of a predetermined command in said program, and
means for generating in said program, based on the analysis results, a path along which said parameter of said predetermined command is fixed in said specific state and for compiling said program, and
wherein said compiler outputs, as the compiled results, said machine language code that includes said path along which the state of said parameter is fixed.

11. A computer comprising:
an input device, for receiving source code for a program;
a compiler, for translating said source code to compile said program and for converting said compiled program into machine language code; and
a processor, for executing said machine language code,
wherein said compiler includes
means for obtaining statistical data for the appearance frequency of each available state wherein a parameter for a predetermined command in said program may be set when said program is executed, and for employing said statistical data to determine a state in which said parameter of said predetermined command is to be fixed, and
means for generating a specialized path along which said parameter of said predetermined command is fixed in said determined state, and for compiling said program, and
wherein said compiler outputs, as the compiled results, said program as said machine language code that includes said specialized path.

12. The computer according to claim 11, comprising:
said compiler further includes
means for compiling said program without generating a specialized path,
wherein, when said state of said parameter to be fixed can not be determined, said means for determining the state of said parameter of said predetermined command outputs, as compiled results, said program in said machine language code, which is generated by said means for compiling said program without generating said specialized path, that does not include said specialized path.

13. A support program, for controlling a computer to support generation of a program, which permits said computer to perform:
a function for performing an analysis to determine whether the execution speed of said program can be increased by fixing a parameter of a predetermined command of said computer program in a specific state; and
a function for generating in said program, based on the analysis results, a path along which said parameter of said predetermined command is fixed in said specific state.

14. A support program, for controlling a computer to support generation of a program, which permits said computer to perform:
a function for executing said program and obtaining statistical data for the appearance frequency of each available state wherein said parameter of said predetermined command of said program may be set; and
a function for generating in said program, based on said statistical data, a path along which said parameter of said predetermined command is fixed in said specific state.

15. A storage medium on which input means of a computer stores a computer-readable support program, for controlling said computer to support generation of a program, that permits said computer to perform:
a function for performing an analysis to determine whether the execution speed of said program can be increased by fixing a parameter of a predetermined command of said computer program in a specific state; and
a function for generating in said program, based on the analysis results, a path along which said parameter of said predetermined command is fixed in said specific state.

16. A storage medium on which input means of a computer stores a computer-readable support program, for controlling said computer to support generation of a program, that permits said computer to perform:
a function for executing said program and obtaining statistical data for the appearance frequency of each available state wherein said parameter of said predetermined command of said program may be set; and
a function for generating in said program, based on said statistical data, a path along which said parameter of said predetermined command is fixed in said specific state.
